(19) United States
(12) Patent Application Publication
(10) Pub. No.: US 2008/0017305 A1
(43) Pub. Date: Jan. 24, 2008

(54) Method for fabricating multi-layered printed circuit board without via holes

(75) Inventors: Syh-Tau Yeh, Taoyuan City (TW); Yao-Ming Chen, Chong-Li City (TW)

Correspondence Address: BIRCH STEWART KOLASCH & BIRCH, PO BOX 747, FALLS CHURCH, VA, 22040-0747, US

(73) Assignee: TEAMCHEM COMPANY

(21) Appl. No.: 11/490,092

(22) Filed: Jul. 21, 2006

(51) Int. Cl. B32B 37/00

(52) U.S. Cl. 156/278

(57) ABSTRACT

A method for fabricating a multi-layered printed circuit board without via holes is disclosed herein, which includes the steps of: providing a plurality of layers of printed circuit boards each having circuits pre-formed thereon; stacking the plurality of layers of the printed circuit boards; and electrically connecting corresponding pads on the plurality of layers of the printed circuit boards; wherein the circuits to be connected with each other on different layers of the printed circuit boards are electrically connected to the pads that are extended to an edge of the printed circuit boards. The multi-layered printed circuit board without via holes in accordance with the present invention can overcome the prior disadvantages caused by the via holes.

### BACKGROUND OF THE INVENTION

1. Field of the Invention

The present invention relates to a method for fabricating a multi-layered printed circuit board, and in particular to a method for fabricating a multi-layered printed circuit board without via holes.

2. The Prior Arts

Conventional multi-layered flexible printed circuit boards, whether fabricated with Pre-preg hot press lamination or with Build-up Process, utilize via holes to interconnect conductive traces on adjacent layers in order to enable three dimensional arrangement of circuits and substantially reduce the space occupied by the printed circuit boards. However, the conventional methods of fabricating the multi-layered flexible printed circuit boards not only are complicated in fabricating processes, but also cause problems in fabricating. For example, in hot press lamination, the dimension of the flexible printed circuit board can not be easily controlled precisely due to its expansion/contraction. As a result, misalignment occurs when aligning the conductive traces on different layers of the flexible printed circuit board therebetween. Furthermore, to utilize the substrate surface more efficiently, there is a trend to have smaller and smaller via holes, which increases the difficulty in plating the via holes substantially. Additionally, with the increase of trace density within unit area of the substrate, the difficulty of the fabricating process drastically increases as well.

In addition, there exist many problems in utilizing the multi-layered printed circuit boards with via holes. For example, the shape and size of such substrates are fixed and cannot be adjusted to fit to an inner space of electronic products, which hinders the efficient utilization of the space inside the electronic products. To overcome this problem, U.S. Pat. No. 6,005,766 disclosed a multi-layered printed circuit board and a method of fabricating the same, in which a multi-layered board meeting the required electronic product in thickness is fabricated first, and then, is cut off in the redundant area of the substrate to obtain a shape fitting with that of the electronic product. Though this fabricating method solves part of the aforementioned problems, it is too complicated and expensive.

Moreover, in the application of high frequency electronic products, via holes of conventional printed circuit boards are one of the major factors causing the signal loss of electronic products. When the frequency is higher than 1 GHz, the signal loss becomes very obvious. The higher the frequency is, the more obvious the signal loss becomes. This phenomenon is known as via resonance. To solve this problem, a method was disclosed in U.S. Pat. No. 7,013,452, in which two compensating circuits having the same circuit length are added in a circuit layout design. Though this method solves part of the problems, it complicates the circuit design substantially. Another method was disclosed in U.S. Pat. No. 6,593,535 to solve the problem of via resonance, in which a multi-layered wedge-shaped conductive material is inserted into a non-plated via hole to interconnect the traces on different layers. Still another method was disclosed in U.S. Pat. No. 6,661,316, in which appropriate inductance and capacitance are added to a circuit according to actual operational frequency to adjust the frequency response. Though these aforementioned methods solve part of the aforementioned problems, in mass production, they are confronted with problems of high manufacturing cost and complicated fabricating process, thereby resulting in difficulty in their actual applications.

### SUMMARY OF THE INVENTION

A primary objective of the present invention is to provide a method for fabricating a multi-layered printed circuit board without via holes, which can solve the aforementioned problems resulting from the via holes formed on the conventional multi-layered printed circuit board.

To achieve the aforementioned objective, a method for fabricating a multi-layered printed circuit board without via holes in accordance with the present invention comprises the steps of: providing a plurality of layers of printed circuit boards each having circuits pre-formed thereon; stacking the plurality of layers of the printed circuit boards; and electrically connecting corresponding pads on the plurality of layers of the printed circuit boards; wherein the circuits to be connected with each other on different layers of the printed circuit boards are electrically connected to the pads that are extended to an edge of the printed circuit boards.

The method in accordance with the present invention fabricates a multi-layered printed circuit board, which can electrically connect different layers of the printed circuit boards without via holes. Because no via holes are provided in the multi-layered printed circuit board fabricated in accordance with the present invention, there are no problems resulted from the via holes.

The present invention will be apparent to those skilled in the art by reading the following detailed description of preferred embodiments thereof, with reference to the attached drawings.

### BRIEF DESCRIPTION OF THE DRAWINGS

FIG. 1 is an exploded perspective view of a multi-layered printed circuit board without via holes in accordance with an embodiment of the present invention.

FIG. 2 is an assembled view of FIG. 1.

FIG. 3 shows another embodiment of FIG. 1.

FIG. 4 is a perspective view of a multi-layered printed circuit board without via holes in accordance with another embodiment of the present invention.

FIG. 5 is a cross-sectional view showing that electric connections are made between layers of the multi-layered printed circuit board in accordance with an embodiment of the present invention.

FIG. 6 is a cross-sectional view showing that electric connections are made between layers of the multi-layered printed circuit board in accordance with another embodiment of the present invention.

### DETAILED DESCRIPTION OF THE PREFERRED EMBODIMENT

In a method for fabricating a multi-layered printed circuit board without via holes in accordance with the present invention, a plurality of layers of printed circuit board are stacked layer by layer, and then a plurality of pads pre-formed at edges of each printed circuit board are electrically connected together, thereby achieving electric connection of circuits on different layers of the multi-layered printed circuit board.

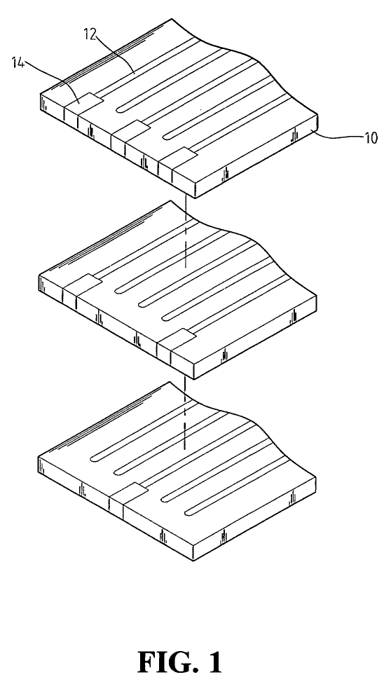

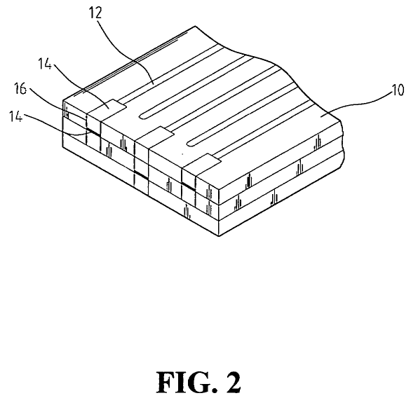

Please to refer to FIGS. 1 and 2, which show a method for fabricating a multi-layered printed circuit board without via holes in accordance with an embodiment of the present invention. Also referring to FIG. 1, first, a plurality of layers of printed circuit boards 10 with required circuits 12 formed thereon is provided. The wiring of the circuits 12 may be obtained using prior techniques and do not have any particular limitation in the present invention. The circuits 12 to be connected with each other on different layers of the printed circuit boards 10 are electrically connected to pads 14 that are extended to an edge of the printed circuit boards 10 or are further extended to a side surface of the printed circuit boards 10 to form a gold-finger-like structure. The pads 14 extended to the edge of each printed circuit board 10 are selectively provided at one of four sides of the printed circuit board 10 according to the needs. After the circuits 12 have been protected and insulated with coverlay or solder mask, the plurality of layers of the printed circuit boards 10 are stacked to form a sandwich structure (see FIG. 2). The coverlay or solder mask mentioned above covers the circuits 12 on the printed circuit boards 10 with the pads 14 left bare.

Next, the pads 14 extended to the edge (or side surface) of the printed circuit boards 10 on various layers are electrically connected 16, thereby connecting the circuits 12 on various layers together. The multiple layers of the printed circuit boards 10 mentioned above may be fixed by any conventional methods, such as stapling, riveting, bonding, binding, or any conventional lamination techniques. The electric connection method mentioned above does not have any particular limitation in the present invention. It can be soldering or electroplating.

In order for easily alignment and connection of the pads 14 therebetween on various layers of the printed circuit boards 10, the width of the pads 14 can be broadened, that is, the width of the pads 14 is greater than that of conductive traces of the circuits 12.

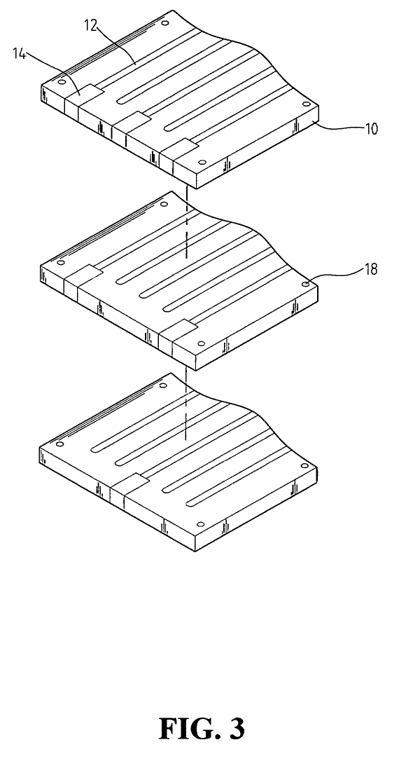

When the multiple layers of the printed circuit boards 10 are stacked, in order to make it easy to meet the alignment demand of the electric connection, such as soldering or electroplating, a plurality of aligning holes 18 are provided on the printed circuit boards 10, as shown in FIG. 3. Therefore, when the aligning holes 18 are aligned, the pads 14 are also aligned. The stacked layers of the printed circuit boards 10 can be bound by hot lamination. Rivets or the like can also be inserted into the aligning holes 18 to fix the stacked layers of the printed circuit boards 10.

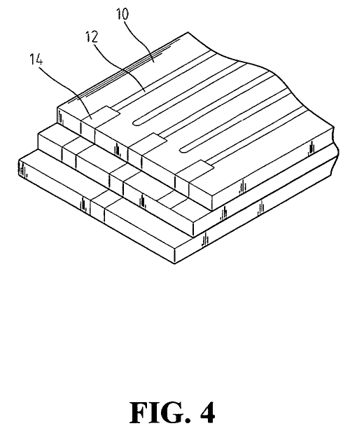

With reference to FIG. 4, which shows another embodiment of the method in accordance with the present invention, the multiple layers of printed circuit boards 10 are stacked in a stepwise shape. An area of an upper layer of printed circuit board 10 is a little smaller than that of an adjacent lower layer of printed circuit board 10, so that the pads 14 on the lower layer of printed circuit board 10 can be bared. Accordingly, it makes the multiple layers of the printed circuit boards 10 easier to align and connect. It also makes the electric connection harder to break circuit.

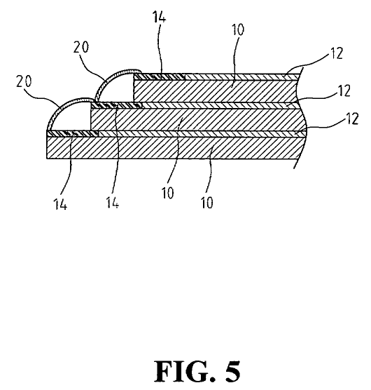

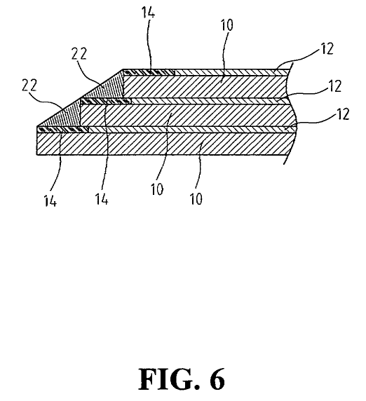

The conventional substrate of the printed circuit board 10 is a dielectric layer. Therefore, as the conventional multiple layers of the printed circuit boards 10 are stacked by the method according to the present invention, the dielectric layers isolate the circuits 12 on various layers of the printed circuit boards 10. As the circuits 12 on various printed circuit boards 10 are to be electrically connected by the method in accordance with the present invention, the pads 14 extended to the edges of the printed circuit boards 10 are soldered together by a bridge 20, as shown in FIG. 5. In order to make the electric connection not easy to be broken, a soldering tin 22 is soldered at side surfaces of the multiple layers of the printed circuit boards 10. It connects the circuits 12 on various layers of the printed circuit boards 10, as shown in FIG. 6. This method not only makes the electric connection between the multiple layers of the printed circuit boards hard to break, but also further enhances the fixation strength of the stacked multi-layered printed circuit board.

A printed circuit board applicable to the present invention is a thin-film printed circuit board, which is conventionally known as a flexible printed circuit board. However, a rigid thin-film printed circuit board can also utilize the method according to the present invention. There is no limitation to the type of the flexible printed circuit board. It may be a two-layer flexible copper clad laminate (FCCL) formed with polyimide film and copper foil, a three-layer FCCL formed with polyimide film, adhesive, and copper foil, or other flexible printed circuit boards. Additionally, the copper foil layer for the circuits on the printed circuit boards applicable to the present invention may be fabricated with but not limited to electric deposited copper foil, roll annealed copper foil, or heat-treated electrolytic copper foil. Roll annealed copper foil is preferred if the flexibility of the printed circuit board is of concern. The thickness of the aforementioned copper foil layer may be fabricated according to the requirements, and is not specifically limited in the present invention.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for fabricating a multi-layered printed circuit board without via holes, comprising the steps of:
(1) providing a plurality of layers of printed circuit boards each having circuits pre-formed thereon;
(2) stacking the plurality of layers of the printed circuit boards; and
(3) electrically connecting corresponding pads on the plurality of layers of the printed circuit boards;
wherein the circuits to be connected with each other on different layers of the printed circuit boards are electrically connected to the pads that are extended to an edge of the printed circuit boards.

2. The method as claimed in claim 1, wherein the pads are further extended to a side surface of the printed circuit boards.

3. The method as claimed in claim 1, wherein in the step (1), surfaces of the printed circuit boards where the circuits are formed, are covered with an insulating layer.

4. The method as claimed in claim 3, wherein the insulating layer is one of coverlay and solder mask.

5. The method as claimed in claim 1, further comprising the step of fixing the stacked printed circuit boards after the step (2).

6. The method as claimed in claim 1, wherein electric connections are formed between the pads on different layers of the printed circuit boards by soldering or electroplating.

7. The method as claimed in claim 1, wherein the width of the pads is greater than that of conductive traces of the circuits.

8. The method as claimed in claim 1, wherein a plurality of aligning holes are provided on the plurality of layers of the printed circuit boards, correspondingly and respectively.

9. The method as claimed in claim 1, wherein the plurality of layers of the printed circuit boards are stacked in a stepwise shape.

10. The method as claimed in claim 1, wherein a copper foil layer served as the circuits on the printed circuit boards are made of the material selected from the group consisting of electric deposited copper foil, roll annealed copper foil, and heat-treated electrolytic copper foil.
